(19) United States
(12) Patent Application Publication
(10) Pub. No.: US 2004/0260445 A1
(43) Pub. Date: Dec. 23, 2004

(54) Electric vehicle stability and obstacle avoidance system

(76) Inventors: Evandro Luis Francischetti, Limeira (BR); Fernando Toshihiko Mitsuyassu, Limeira (BR); Nelson Gosser Junior, Limeira (BR); Sergio Charles Tubero, Sao Paulo (BR); Edson dos Santos, Limeira (BR); Carlos Eduardo Pinotti, Troy, MI (US); Steven Yollick, Troy, MI (US); Jose Henrique Bonaldi, Araras (BR)

Correspondence Address: CARLSON, GASKEY & OLDS, P.C., 400 WEST MAPLE ROAD, SUITE 350, BIRMINGHAM, MI, 48009, US

(21) Appl. No.: 10/463,456

(22) Filed: Jun. 17, 2003

(51) Int. Cl. G06G 7/00; G06F 7/70

(52) U.S. Cl. 701/70; 701/75; 701/96

(57) ABSTRACT

An obstacle avoidance and vehicle stability system as provided that includes a plurality of wheels, each driven by an independent electric motor. Each of the electric motors provides rotational drive to its respective wheel. The electric motors may also provide braking through a retarding force. A controller is electrically connected to the electric motors. A plurality of vehicle sensors are electrically connected to the controller for detecting vehicle information indicative of vehicle stability. The controller receives information from the vehicle sensors and controls the electric motors and braking device to maintain vehicle stability, for example, during a hard braking maneuver to avoid a collision with an obstacle. The controller commands the appropriate electric motor and/or braking device to accelerate and/or decelerate the appropriate wheel to maintain control of the vehicle.

### BACKGROUND OF THE INVENTION

This invention relates to a collision avoidance and vehicle stability system, more particularly, the invention relates to a vehicle with an electric drive system.

Vehicles, in particular commercial vehicles, have incorporated collision avoidance systems. The collision avoidance systems detect the distance from the vehicle to an object and relate the distance to the vehicle speed and acceleration to determine if a collision is imminent. If a collision is imminent, then the driver is warned using an alarm to alert the driver that an evasive maneuver is required.

Vehicles have incorporated stability systems to maintain control of the vehicle during hard braking of the vehicle. Anti-lock braking may be selectively applied to the wheels to maintain control of the vehicle and maximize the traction between wheels and roadway. Since passenger and commercial vehicles typically utilize an internal combustion engine to drive all the wheels through a gear train, the stability systems may only use braking to provide independent control of the wheels. That is, the rate of rotation of each of the wheels is varied by using the anti-lock braking system to maintain control of the vehicle. Each of the wheels are not independently driveable relative to one another.

Therefore, what is needed is an integrated collision avoidance and vehicle stability system for a vehicle having improved independent control of each of the wheels.

### SUMMARY OF THE INVENTION AND ADVANTAGES

The present invention obstacle avoidance and vehicle stability system includes a plurality of wheels, preferably four, each driven by an independent electric motor. Each of the electric motors provides rotational drive to its respective wheel. The electric motors may also provide braking or a conventional mechanical brake may be used. A controller is electrically connected to the electric motors. A plurality of vehicle sensors are electrically connected to the controller for detecting vehicle information. For example, the vehicle sensors may include object sensors such as optical radar sensors for detecting obstacles in proximity to the vehicle, which may pose a threat. Other vehicle sensors may include vehicle speed sensors and accelerometers for monitoring the vehicle speed and acceleration. The controller receives information from the vehicle sensors and controls the electric motors and braking device to maintain vehicle stability, for example, during a hard braking maneuver to avoid a collision with an obstacle. The controller commands the appropriate electric motor and/or braking device to accelerate and/or decelerate the appropriate wheel to maintain control of the vehicle.

Accordingly, the present invention provides an integrated collision avoidance and vehicle stability system for a vehicle having improved independent control of each of the wheels.

### BRIEF DESCRIPTION OF THE DRAWINGS

Other advantages of the present invention can be understood by reference to the following detailed description when considered in connection with the accompanying drawings wherein:

FIG. 1 schematically depicts a vehicle having the present invention integrated collision avoidance and vehicle stability system using independent electric motors; and

FIG. 2 is a flowchart depicting the present invention method of providing collision avoidance and stability to a vehicle.

### DETAILED DESCRIPTION OF THE PREFERRED EMBODIMENT

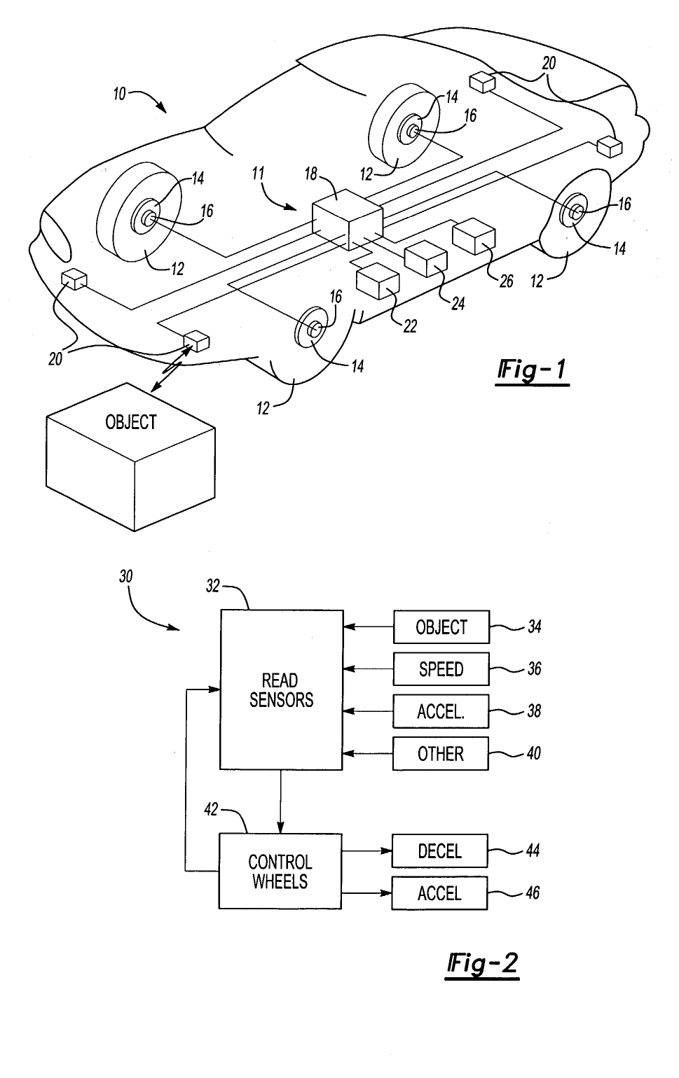

A vehicle 10 is shown schematically in FIG. 1. The vehicle 10 includes the present invention collision avoidance and vehicle stability system 11. The system 11 includes wheels 12 each rotationally driven by electric motors 14. The motors 14 may include a rotor and stator configuration suitable for driving the wheels of a vehicle. Each wheel 12 includes a brake associated with the wheel to provide a braking force to slow or decelerate the vehicle. The brakes 16 may be conventional mechanical brakes, and other suitable brake used for braking vehicles, or the braking may be provided by the electric motors 14. For example, the brakes 16 may be provided by retarding the motors 14 by introducing a current to the stator that would cause a rotation of the rotor in the opposite direction of the wheel drive direction, which is known in the art.

A controller 18 is electrically connected to each of the motors 14 and brakes 16 to monitor their operation as necessary and command the motors 14 and brakes 16 to maintain vehicle stability. Object sensors 20 such as optical or radar sensors may be positioned about the vehicle 10 to detect objects in proximity to the vehicle 10 that may be hazardous. The information obtained by the controller 18 from the object sensors 20 is used to command the motors 14 and brakes 16 to automatically maintain vehicle stability.

A speed sensor 22 is electrically connected to the controller for providing vehicle speed information to the controller 18. The speed sensor 22 may be vehicle speed information obtained from another vehicle control system. An accelerometer 24 may be electrically connected to the controller 18 to detect rapid acceleration or deceleration that may introduce an instability to the vehicle 10. Other sensors 26 may also be electrically connected to the controller 18 to provide additional vehicle information usable in maintaining vehicle stability. For example, other sensors may include steering position, lateral acceleration sensors, roll sensors, and load sensors.

Referring to FIG. 2, operation of the system 11 as shown in FIG. 1 is depicted as a block diagram at 30. The controller reads all of the sensors, as indicated at block 32. As indicated by the following blocks, information is received from the object sensor 34, the speed sensor 36, the accelerometer 38, and other sensors 40. The controller 18 reads the sensors, as indicated out at block 32, and commands each of the motors 14 and brakes 16 as appropriate to maintain the stability of the vehicle 10. Specifically, the controller 18 may decelerate some of the wheels 12, as indicated at block 44, to slow certain wheels. The wheels 12 may be decelerated by retarding the motors 14 or by applying a conventional, mechanical or external brake 16. While some of the wheels are being decelerated, the controller 18 may be commanding other wheels to be accelerated, as indicated at block 46, by independently driving the appropriate wheel 12 with the associated motor 14. Providing the ability to accelerate each wheel independently in addition to decelerating each wheel independently better enables the vehicle to be maintained in the desired direction of travel. In this manner, unlike the application of anti-lock braking to all of the wheels, the present invention is able to accelerate some of the wheels as needed to further enhance the stability of the vehicle 10.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A vehicle control system comprising:
first and second wheels;
first and second electric motors coupled to said first and second wheels respectively for applying a rotational drive to each of said wheels independently;
first and second braking devices respectively associated with said first and second wheels for decelerating said wheels independently;
a controller connected to said motors and said brakes to independently accelerate or decelerate said wheels; and
a vehicle sensor electrically connected with said controller providing vehicle information to said controller indicative of vehicle stability.

2. The system according to claim 1, wherein said vehicle sensor includes an object sensor.

3. The system according to claim 1, wherein said vehicle sensor includes a speed sensor.

4. The system according to claim 1, wherein said vehicle sensor includes an accelerometer.

5. The system according to claim 1, wherein said first and second motors respectively include said first and second braking devices, and wherein said braking devices are defined by a current within said motors producing a retarding force in a direction opposite from a wheel rotation direction.

6. The system according to claim 1, further including third and fourth wheels with third and fourth electric motors coupled to said third and fourth wheels for independently producing an acceleration of said wheels, and third and fourth braking devices respectively associated with said third and fourth wheels for independently producing a deceleration of said wheels.

7. A method of providing stability to a vehicle comprising the steps of:
a) detecting vehicle conditions indicative of vehicle stability; and
b) commanding electric motors coupled to wheels independently from one another to maintain vehicle stability.

8. The method according to claim 7, wherein the vehicle condition is vehicle speed.

9. The method according to claim 7, wherein the vehicle condition is vehicle acceleration.

10. The method according to claim 7, wherein the vehicle condition is vehicle braking relative to an object in proximity to the vehicle.

11. The method according to claim 7, wherein step b) includes effecting a acceleration of a wheel independently from another wheel.

12. The method according to claim 7, wherein step c) includes independently effecting a deceleration of a wheel from another wheel by producing a retarding force with the electric motor.
